(19) United States
(12) Patent Application Publication
(10) Pub. No.: US 2007/0083421 A1
(43) Pub. Date: Apr. 12, 2007

(54) BUSINESS PROCESS MODEL DESIGN MEASUREMENT

(75) Inventors: DOUGLAS S. MCNAIR, OVERLAND PARK, KS (US); DAVID TOMMY KEARNS, OVERLAND PARK, KS (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC., OVERLAND PARK, KS (US)

(21) Appl. No.: 11/464,528

(22) Filed: Aug. 15, 2006

Related U.S. Application Data
(60) Provisional application No. 60/724,982, filed on Oct. 7, 2005.

(51) Int. Cl. G06Q 99/00; G07G 1/00; G06F 17/30

(52) U.S. Cl. 705/10; 705/1

(57) ABSTRACT

Systems, methods, and apparatuses are provided for aiding in the development of Business Process Model (BPM) design. A BPM Design is created by a design editor, and contains model data that describes the design. The design is stored in a datastore. Sets of measurements are derived from the model data that express measures such as complexity, maintainability, or productivity of the design. A measurement calculator derives sets of measurements based on model data from designs. A design planner accesses the datastore and makes use of measurements as an aid to BPM Design. A display generator receives measurements and processes them so that they may be displayed to a user and readily interpreted as an aid to BPM Design, development, or management.

### CROSS-REFERENCE TO RELATED APPLICATIONS

This application claims the benefit of U.S. Provisional Application No. 60/724,982, filed Oct. 7, 2005.

### STATEMENT REGARDING FEDERALLY SPONSORED RESEARCH OR DEVELOPMENT

Not applicable.

### BACKGROUND

Business delivers goods or services through the management of property such as land, labor, and capital. Traditionally, business considers the problem of managing property in one form to produce property in another form. The manager considers the use of a factory to produce widgets. Particularly in the modern economy, business may also include a wide variety of endeavors. Business may include any endeavor which provides a good or service such as manufacturing, engineering, advertising, retail sales, hotel service, banking, medical service, web-development, ecommerce, etc.

Recently it has become popular to think about business management as the management of processes rather than property. Successful business activity is defined in terms of desired results of the activity such as profit, avoidance of legal risk, administrative uniformity, reputation, successful outcome, etc. The process is then managed by determining an acceptable standard process, and supervising activity to insure conformance to the standard. This approach to management is sometimes called Business Process Modeling (BPM). There has been a very successful effort to convince managers to use BPM as a method to improve their effectiveness as managers. Management will often speak in favor of BPM as one method among other possible methods for managing a business. It is also common in the art to refer to a process description or model associated with BPM as a Business Process Model. For the purpose of clarity in distinguishing between the activity and a description of a process, the activity will be generally referred to as BPM, while a particular description of a process will be referred to herein as a “BPM Design,” or a “BPM Model,” or more succinctly as a “model” or “design.”

BPM offers advantages over the traditional view of management. The traditional view of business is static, focusing as it does on property. A manager does not have direct influence over the state of affairs. A manager does have direct influence over the activities that are performed under his supervision. The use of BPM allows the manager to consider what he may directly effect, linking his direction of activity to the desired outcomes. The use of BPM is also more frequently adapted to the modern service-oriented businesses that are rising in popularity in the information age. There is a general need for tools and methods that allow BPM to be successfully carried out. There is a general need for these tools and methods to be efficient and helpful to the business manager, or to the analyst who evaluates existing processes.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter. Embodiments of the present invention relate to systems, methods, and apparatuses that provide a quantitative approach to the development and management of the BPM design process.

One aspect of the present invention provides a computerized method for the development of BPM Designs. A first BPM Design is created, and contains model data that describes the design. The design is stored in a datastore. Sets of measurements are derived from the model data that express such metrics as complexity, maintainability, testability, reliability, or productivity of the design. These sets of measurements are then used as an aid to BPM design.

In another aspect, the present invention provides a computerized system for development of BPM Designs. A design editor creates BPM Designs which include model data. A datastore stores the BPM Designs that have been created by the editor. A measurement calculator derives sets of measurements based on model data from BPM design. A design planner accesses the datastore and makes use of the measurements as an aid to BPM design.

In yet another aspect, the present invention provides an apparatus for analysis of BPM Designs. A datastore holds BPM Designs. A measurement calculator has access to this datastore, and operates to derive a first set of one or more measures based on model data from a BPM Design. A display generator receives measurements that were made by the measurement calculator and processes them so that they may be displayed to a user and readily interpreted as an aid to BPM Design development or management. For example, a report could be generated depicting various measures for display on a monitor or for printing on a printer.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram showing an exemplary overall system architecture in which BPM design may be performed in accordance with an embodiment of the present invention;

FIG. 3 is a flow diagram showing an overall method for business process optimization in accordance with an embodiment of the present invention;

FIG. 4 is a flow diagram showing a general method for development of a BPM Design;

FIG. 5 is a flow diagram showing a method for aiding the development of a BPM Design;

FIG. 6 is a system for aiding the development of a BPM Design;

FIG. 7 is an apparatus for analysis of a BPM Design; and

FIG. 8 is an exemplary display of two sets of BPM Design measurements.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

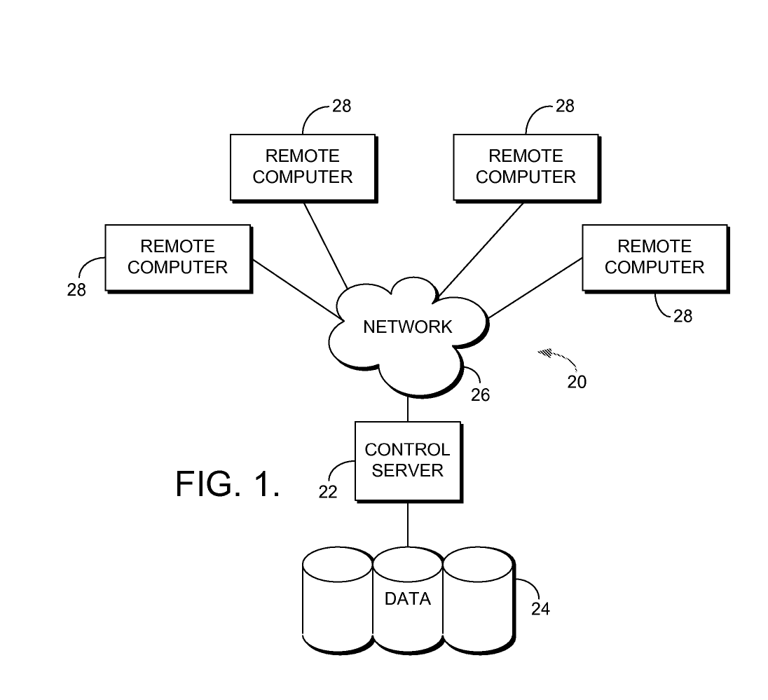

Embodiments of the present invention provide computerized methods, systems, and apparatus for analysis and aid of BPM design. Having briefly provided an overview of the present invention, embodiments of the invention will be discussed with reference to FIGS. 1-8.

Software development goes through a number of phases. Typically these phases are described as comprising a requirements, design, implementation, test, installation and maintenance phases. The requirements phase identifies the results that the software must produce, and relates specific needs of the eventual users of the software to the goals of the design. The design phase identifies the tools that will be used to implement the software, and the hierarchical constraints on the design, such as which processes and sub-processes will be used for which functions. The implementation phase produces the actual code that will be compiled or interpreted to fulfill the requirements of the project as constrained by the completed design. The Test phase attempts to demonstrate the successful implementation of the code by evaluating the code's ability to address the requirements in a number of tests. The installation phase begins when the software has sufficiently succeeded in proving functionality and is released in a delivered setting. Changes that take place to address problems in the field are managed through a change management system. In the maintenance phase, the code is monitored for continued acceptable operation and modified as defects are discovered.

As systems become larger, a greater portion of the costs derive from maintenance costs. Therefore, in large software systems, the maintenance phase of development requires special emphasis and study. Efforts to improve performance during the maintenance phase may focus on decreasing the number of defects, decreasing the cost of defects, enhancing functionality during maintenance, improving performance during maintenance, or adapting to a changing business or technology environment. The consideration of the total cost of software makes an effort to weigh these maintenance costs against increased development costs. This perspective is sometimes called consideration of the Software Development Life Cycle (SDLC).

Numerous techniques exist to aid in the management of software development and the SDLC. Software measurement is an effective aid to the satisfactory development of computerized software systems. Typically, measures are identified, and are used to evaluate a given aspect of a system or project. For example, a selected measure indicates the complexity of a software program. This measure can then be used as an aid to manage the cost of software development, the cost of software maintenance, and the cost of software testing. These costs are directly associated with resource time, and indirectly with assessing the risk of soundness and errors.

In some ways the development of BPM “designs” is similar to software development. BPM is a discipline which uses a modeling language to document and capture the definitions of business processes. A BPM language typically includes a graphical notation for visual design, and grammatical rules that indicate structure, relationships, and flow. A BPM language may be both “procedural” and “declarative.” “Procedural” means specifying a sequence of steps to produce a result. “Declarative” means describing the relationships of a process to the people, systems and organization. Software languages may also be procedural and declarative. The difference between software development and business development stems from the fact that business processes are carried out by a company of people who perform the process, while software processes are executed or interpreted by computing machinery. The organizations that develop BPM Designs may be as diverse as business. BPM Designs may be developed to describe processes that take place in retail sales, hotel service, banking, medical facilities, etc. Many processes are implemented in an ad-hoc manner, with very few BPM Designs describing the processes. A “BPM Design” as used herein indicates an electronic collection of data that serves to document some important aspect of a BPM that is being studied, compared to other processes, or is a candidate for change or improvement. Some modeling efforts are instituted as the result of a simple policy decision irrespective of costs or necessary resources. There tends to be push-back from some participants who must cooperate to develop accurate models of a process under study. For this reason, there is a general need for tools to aid in the analysis and management of BPM design efforts. Specifically, there is a need to make informed decisions about the costs and resources needed for a modeling effort, to manage cost of model development, and to manage project plans and time lines related to BPM design.

Referring to the drawings in general, and initially to FIG. 1 in particular, an exemplary computing system environment, for instance, a business information computing system, on which embodiments of the present invention may be implemented is illustrated and designated generally as reference numeral 20. It will be understood and appreciated by those of ordinary skill in the art that the illustrated business information computing system environment 20 is merely an example of one suitable computing environment and is not intended to suggest any limitation as to the scope of use or functionality of the invention. Neither should the environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary business information computing system environment 20 includes a general purpose computing device in the form of a server 22. Components of the server 22 may include, without limitation, a processing unit, internal system memory, and a suitable system bus for coupling various system components, including database cluster 24, with the server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 22 typically includes, or has access to, a variety of computer readable media, for instance, database cluster 24. Computer readable media can be any available media that may be accessed by server 22, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for the server 22.

The server 22 may operate in a computer network 26 using logical connections to one or more remote computers 28. Remote computers 28 may be located at a variety of locations in a business environment. Taking an exemplary application to be Medical Business Process Design, the remote computers 28 may be located in a variety of environments. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the components described above in relation to the server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the server 22 may include a modem or other means for establishing communications over the WAN, such as the Internet. In a networked environment, program modules or portions thereof may be stored in the server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., server 22 and remote computers 28) may be utilized.

In operation, a user may enter commands and information into the server 22 or convey the commands and information to the server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote business device to the server 22. In addition to a monitor, the server 22 and/or remote computers 28 may include other peripheral output devices, such as speakers and a printer.

Although many other internal components of the server 22 and the remote computers 28 are not shown, those of ordinary skill in the art will appreciate that such components and their interconnection are well known. Accordingly, additional details concerning the internal construction of the server 22 and the remote computers 28 are not further disclosed herein.

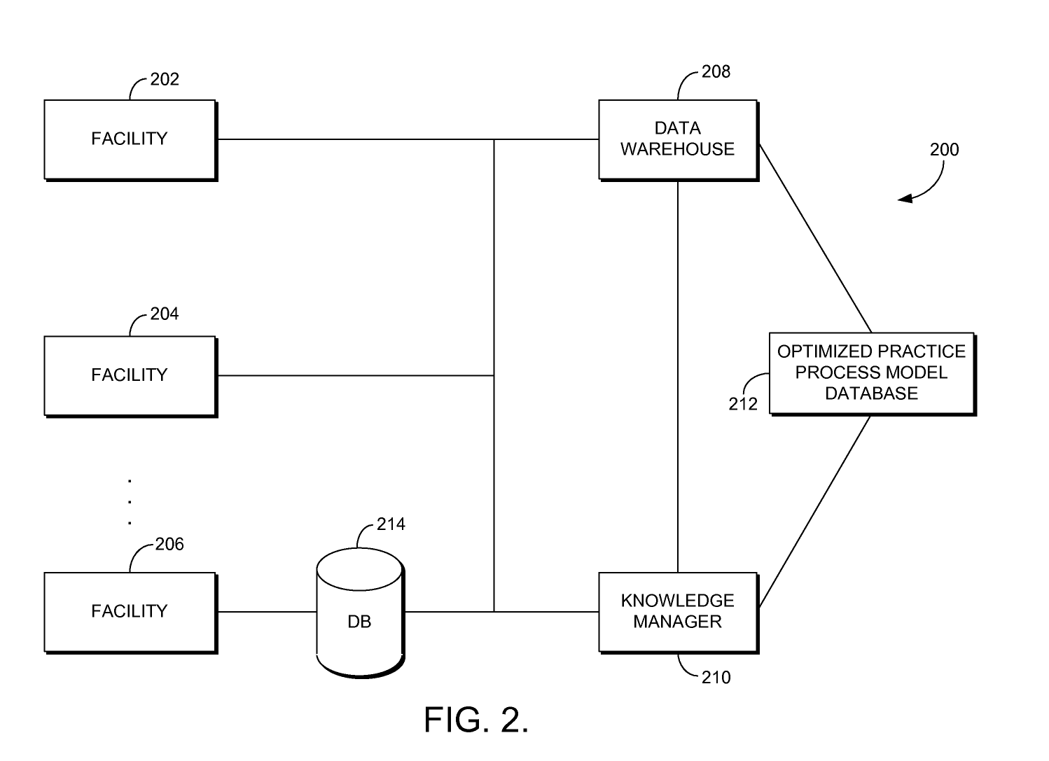

Having described an exemplary computing system environment, an exemplary overall system architecture 200 in which embodiments of the present invention may be employed is shown in FIG. 2. The overall system architecture 200 may include a number of locations, such as the locations 202, 204, 206, a data warehouse 208, a knowledge manager 210, and an optimized practice process model database 212. The overall system architecture 200 shown in FIG. 2 is illustrative, and modifications in configuration and implementation will occur to persons skilled in the art. For instance, while the overall system architecture 200 is shown with only a single knowledge manager 210, in embodiments, multiple components may be employed independently or together to analyze opportunities for process optimization within locations. Likewise, in various embodiments, more than one data warehouse and optimized practice process model database may be employed. Further, components shown separately within FIG. 2 may be combined in embodiments of the present invention.

The overall system architecture 200 shown in FIG. 2 provides a system that may be employed to identify and analyze opportunities to improve business processes within a location or set of locations (e.g., a collection of locations within a business information system). Opportunities for process optimization may be identified by comparing current measures from a location against other measures related to other BPM Designs, for example measures from a benchmark BPM Design.

The optimized practice process model database 212 may store one or more optimized practice process models, each of which contains data relating to an optimal business process. Each optimal business process details the activities required within the end-to-end process flow, including but not limited to, the actors and venues required to accomplish each activity. By defining an optimal process, embodiments of the present invention recognize and account for interrelationships between activities within a process flow, thereby providing a significant advantage over other approaches in which individual pieces of evidence are used in isolation of an overall end-to-end process.

The optimal process may be defined based on a variety of different data within the scope of the present invention. Typically, available literature and best published evidence may be used to define the optimal process. In addition, operational evidence collected from a variety of locations (such as that stored in the data warehouse 208 described in further detail below), may be used to define the optimal process. One skilled in the art will recognize that a variety of other data may also be used within the scope of the present invention.

Within each optimal process, activities that have the greatest impact on outcomes are identified as critical levers within the data. In other words, the critical levers represent those activities that present the greatest opportunities for optimizing the process. Information related to the opportunity for process improvement for each critical lever may also be defined and stored within the optimal practice process model database 212. Generally, each critical lever may represent a clinical, regulatory, operational, and/or financial opportunity. In addition, data may be provided in the optimal practice process model database 212 to allow for the quantification of both financial and non-financial benefits of each opportunity to allow prioritization of identified opportunities. Further, because the optimal process within an optimized practice process model details the end-to-end activities of a particular process, the models contain data regarding the changes necessary to adopt identified opportunities.

The optimized practice process model database 212 may be in communication with the knowledge manager 210, which may be employed to perform opportunity identification and analysis. In particular, the knowledge manager 210 may access a location's current performance with respect to critical levers for a particular process, and may compare this performance to a reference level of performance such as a benchmark or target level of performance. The performance may be extracted from the process model database 214, the data warehouse 208, and/or another associated database. Through the comparison, opportunities for process optimization for the location may be identified. The knowledge manager 210 further generates one or more outputs such as a user interface or an XML report to allow a user to analyze the identified opportunities and determine which opportunities to adopt and integrate into a current process.

The knowledge manager 210 may likewise be in communication with a source of data relating to one or more locations. The knowledge manager 210 may access data regarding a location from the location itself or from a data warehouse, such as the data warehouse 208, which may store data from a number of different locations. A location may have the ability to collect and condition captures of process-related data. In some cases, a database may be associated with a location for storing the process-related data, such as the database 214 shown with location 206. Each location may further communicate the process-related data to the knowledge manager 210 and/or the data warehouse 208. Process-related data may include, for example, a variety of customer satisfaction, medical, financial, operational, administrative, and other information.

The data warehouse 208 may collect and store process-related data from multiple locations. The collection of data from multiple locations may provide a number of advantages. For example, a benchmark may be determined based on the provided data. A first BPM Design that resulted in a highly successful modeling effort may have included 187 elements. Another BPM Design may be compared to the benchmark favorably because it only has 150 elements. Such benchmark data may permit locations to compare their performance against their peers. In addition, the collection of data may be used for various other analytic purposes. For example, if a particular location is outperforming other locations, its process-related data may be compared against its peers to determine why the location is outperforming. Further, the collection of data may be used to improve the optimized practice process models.

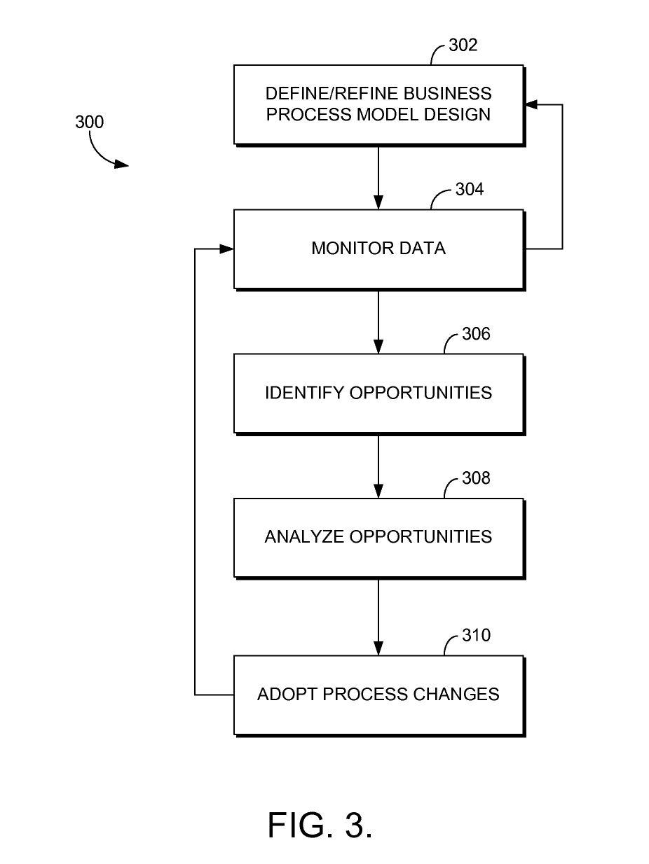

Referring to FIG. 3, a flowchart is provided illustrating an exemplary overall process flow 300 for process optimization in accordance with embodiments of the present invention. Generally, the overall method may be referred to as a closed-loop, cyclical process that allows for the continuous improvement and refinement of processes within locations. As shown at block 302, a business process model design is defined for a particular process. As discussed previously, each practice process model contains data relating to what may be considered as an optimal procedure for a particular process. Process-related data may be monitored and collected from a location, as shown at block 304. In particular, the data monitored and collected includes current performance of the critical levers that were identified for the particular process under review. Using the monitored data and the process model for the particular process, opportunities for process improvement may be identified, as shown at block 306. After identifying opportunities for process optimization, the various identified opportunities may be analyzed, as shown at block 308. As mentioned above, the knowledge manager may provide a number of graphical user interfaces that a user may navigate to examine the various opportunities. The interfaces may allow the user to view the identified opportunities, as well as a variety of different aspects of the opportunities, for example, the activities/critical levers with which the opportunities are associated and their location within the optimal process flow, the type of opportunity (clinical, financial, operational and/or regulatory), the financial benefits of the opportunities, and the return on investment for the opportunities.

Using the graphical user interfaces provided by the knowledge manager, a user may prioritize the various opportunities and determine which opportunities to adopt. Based on that determination, the selected opportunities may be adopted and integrated into the current process for the location, as shown at block 310. Because the optimized practice process model includes detailed information regarding the optimal process, the model provides information regarding how to integrate the opportunities (e.g., changes required, actors and venues involved, etc.)

As mentioned previously, embodiments of the present invention provide a closed-loop approach to continuously improve the processes of locations. Accordingly, as illustrated in FIG. 3, the process typically does not end with the adoption of selected opportunities. Instead, the location's operations are continuously monitored, as shown by the return to block 304, to allow for the identification and evaluation of out-of-tolerance conditions, as well as identifying and analyzing further opportunities for process optimization by repeating the process described with reference to block 304 through 310. Typically, a location may have the resources or ability to adopt only a subset of all identified opportunities at a given time. Accordingly, the process of identifying, analyzing, and adopting opportunities may be continuously repeated as appropriate for the location.

As further represented in FIG. 3, by continuously monitoring and collecting data from multiple locations, as well as evaluating the actual success of adopted opportunities, the optimized practice process model may be refined, allowing for further process optimization. For example, the collected data may be used to either confirm or contradict existing information (publication, guideline, empirical data, etc.) that was used to define a particular portion of the optimal process and/or used to set an optimal performance level for a critical lever. In addition, the collected data may be used to define portions of the model in which no information is currently available or may prompt further research and trials. Further, if one location is determined to be outperforming its peers, the data may be evaluated to determine why the location is outperforming, and the optimized practice process model may be accordingly refined based on that evaluation.

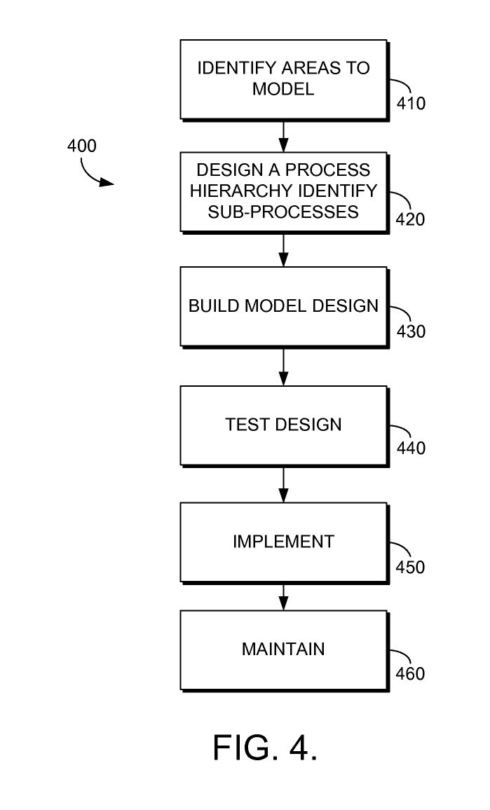

Turning now to FIG. 4, there is depicted in 400 a flow diagram showing a general method for developing a BPM Design. From a business perspective the purpose of BPM is to achieve a particular performance goal related to an identified critical lever. For example, a process improvement is undertaken to achieve better efficiency, a higher value service, or a lower rate of failure. The performance goal is then the direct business purpose and result of the modeling effort. As a byproduct of the BPM effort, one or more BPM Designs are produced. Ordinarily a business does not derive a direct benefit from the designs that have been produced from a BPM effort. The costs and resources needed for performing a BPM effort must therefore be justified based on the performance improvements identified in the critical levers. With respect to developing and managing the resources and costs related to a BPM effort, it is convenient to consider the design process as producing one or more BPM Designs as depicted in method 400. This ordinarily is the result of a belief that the modeling effort is likely to produce a performance improvement sufficient to justify the modeling expenses. The particular business process is identified, and the aspects that need to be better understood are also identified. The purpose of the model design may be to capture the process used by a location which is performing the process well, or it may be to improve a process at a location that is thought to be inefficient. At 420 the structure of the design is determined by identifying a hierarchy appropriate to the areas that are being modeled. If some of the sub-processes have already been modeled previously, those designs may be adapted to the present modeling effort to decrease the cost of design. The design approach may also take into account constraints placed on the design such as what modeling language may be used, and how to break down the processes by role of the actor, or organizations involved. At 430 the actual design is built. This means that the business process is documented and captured. The assembly of the first workable version of the model design typically takes place in 430, however, modifications of the data describing the process may take place in the design 440, implementation 450 and maintenance 460 phases.

The building of the subject design for the current method may take place through the use of visual design by placing graphical components, and it may also involve the use of grammatical rules expressing structure, relationships between blocks, and flow. The resulting design may have both procedural and declarative elements. The locus of all data related to a particular design that expresses the content and structure of a process is generically called “model data.” Model data may encompass a UML expression of one or more components of the process. Model data may include an object oriented interrelation of primitive elements. Model data may make use of workflow descriptions, cost attributes based on activities, and flow charts. Model data may be recorded in a proprietary, industry standard, or open format. In general, all of the data that may be used to document a process is included in model data. Model data is recorded to obtain a description of how a process may be performed by a location.

At 440 the design is tested. Testing is performed to bring to light non-functionality, incompleteness or inaccuracy in the model design. Testing may make use of simulating the process by doing a dry-run going through the motions of the process without actually carrying out all of the functions indicated. Testing may also include peer review with those who may have to make use of the process. Testing may also include scripting one or more scenarios that the process should be effective in handling, and evaluating the BPM Design's capability to allow for them in an acceptable manner. Testing may also include the use of a reference design, while recording inaccuracies and deficiencies.

At 450 the design is implemented. This means that the BPM Design is used as the proper process in one or more locations in a “live” implementation of the process. Depending upon the purpose of the model design effort, inconsistencies between the model design and the process used at a location will be handled differently. For example, if the purpose of the model design was to capture a best practice at one of the locations, inconsistencies will likely be resolved by changing the design as built. As a second example, if the purpose of the model design was to improve efficiency, the practices within the location will be changed to conform to the dictates of the BPM Design.

At 460 the BPM Design is maintained so that it remains an accurate description of the process that was modeled. Changes in the design may be undertaken in the interest of improving performance with respect to one of the critical levers. This means that modifications will need to be made to the pre-existing BPM Design. It is also possible for the locations to reorganize so that the roles of the actors and the organizations may need to be adjusted to fit the new structure. Those skilled in the art recognize that there are many such causes for the BPM Designs to be maintained.

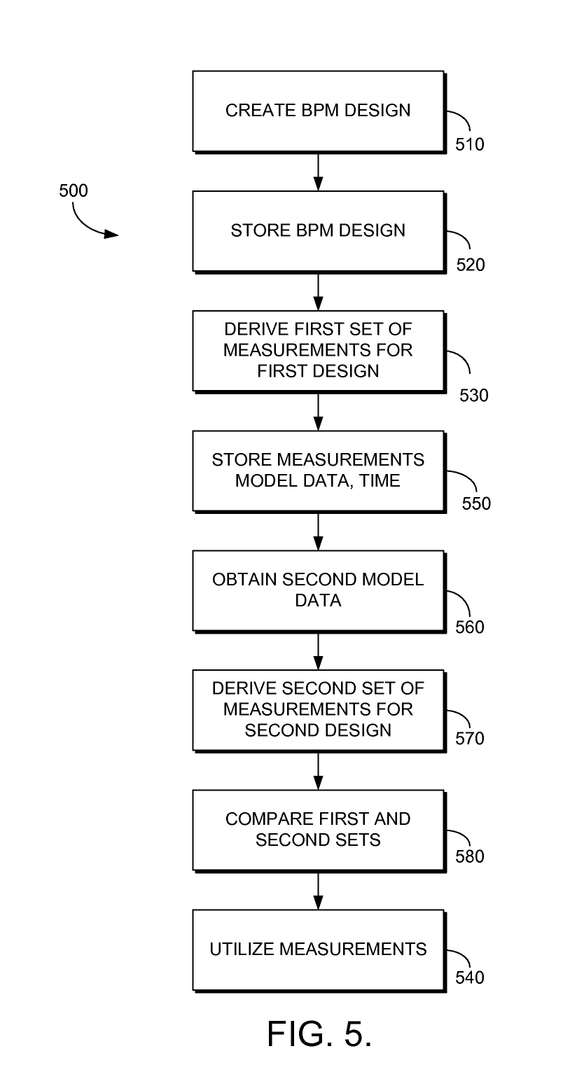

Turning now to FIG. 5, there is depicted in 500 a flow diagram for aiding the development of a BPM Design. In general the steps taken to create the design may take place according to one or more steps discussed in association with FIG. 4. Those skilled in the art will appreciate that the formality and existence of some of these steps of FIG. 4 may be omitted for some projects, and that large modeling efforts are typically more explicit in following the steps. At 510 a BPM “design” is created to define the content and structure of the process being modeled by the design. A design editor is simply an application that allows designs to be defined, retrieved, and/or modified. A design editor may be a local or remote application that runs on a remote computer such as 28 or a server such as 22. The design editor may be a stand-alone application or a component of an application that is operated by a user in a location such as 206, or it may be a component of another application such as a knowledge manager 210. As depicted in FIG. 3 at step 302, the design may be created as the result of one entry session, or it may be iteratively completed over multiple sessions of data entry at different times or stages. The creation process may involve the use of existing templates or library elements that are completed or modified to create a portion of the design, or perhaps even the entire design. Preferably the design editor makes use of a user interface for entry and display, and stores results in a known, structured, and documented format.

At 520 the created design, including constituent model data is stored in a datastore. The datastore may be distributed into a number of storage locations in remote computers such as 28, or it may be housed in a database cluster such as 24. The datastore may be a database that is local to a location such as 214, or it may be a centralized data warehouse such as 208, or it may be an optimized practice database such as 212. The datastore may further comprise one or more libraries. A library is simply a set of designs that are grouped together either logically or locally. For example, a local datastore 214 may have a library for one segment of its operations such as “customer service” and a second library for another segment of its operations such as “shipping”. The library may contain the elements themselves or pointers to the elements as they are available on the network. For example, a local library in the datastore 214 may have a pointer to a design for overnight shipping that is located in the current optimized practice database 214. A library may also contain an archive of all iterations of a design stored for example in a data warehouse 208. Likewise a library may contain a mirror image of an entire database or library from a remote location. Those skilled in the art will appreciate that there are many similar alternatives to storage and sharing of libraries as they are simply groups of existing designs.

At 530 a set of measurements is derived from a first BPM Design. The derivation takes place by processing the model data from a design applying one or more techniques to form a set of indicators. The indicators may be used directly as measurements of a particular aspect of the design process that is being measured, or they may be combined with other indicators to form one or more measures. The calculation of the indicators parallels the use of indicators and measures in the development and management of software.

A number of techniques have been employed for the purpose of indicating different aspects of developed software. A first technique is the calculation of source code line count. The number of lines of code used in program, is an indicator that is often used as a measure of the maintainability of the program. The larger the line count, the more support needed to maintain the program. Function Point Analysis (FPA) is another technique used to indicate aspects of a software module. FPA analyzes and counts five different aspects of a software system: inputs, outputs, inquiries, interfaces, and files. Halstead Complexity is yet another indicator of aspects of a program. Halstead complexity is a set of indicators based on source code operators and operands used as an indication of complexity and maintainability. The five indicators are: program length, program vocabulary, volume, difficulty, and effort. Cyclomatic complexity is yet another technique for indicating aspects of a software program. This indicates the number of paths through a program. It is a direct indicator of the complexity of the code based on the minimum number of inputs needed to test all possible paths through a program.

Indicators of software aspects are used as a direct or indirect indication of various quality measures. Quality measures include satisfaction, performance, maintenance, adaptive, and organizational. Satisfaction measurements generally encompass an indication of the acceptable achievement of requirements. Examples of satisfaction measures are effectiveness, responsiveness, correctness, and verifiability. Satisfaction measurements are related to complexity indicators, and maintainability indicators. Performance measures generally encompass an indication of the successful performance to an operator. Examples of performance measures are: Dependability, efficiency, usability and fidelity. Maintenance measures generally encompass an indication of the ability to be understood and maintained. Examples of maintenance measures include maintainability, understandability, and conformance to design constraints such as: modularity standards, object-oriented standards, documentation standards, analysis standards, and good design practices. Maintenance measures are related to Source code line count, Function Point analysis, Halstead Complexity and Cyclomatic complexity indicators. Adaptive measures generally encompass the ability to achieve beneficial design goals. Examples of adaptive measurements include interoperability, portability, and reusability. Organizational measurements generally encompass cost of ownership including cost of operation, cost of maintenance and operational lifetime, and productivity. Organizational measurements are related to FPA. As appreciated by those skilled in the art, other mappings between indicators and measurements are possible and included within the scope of the present invention.

The present invention advantageously applies the software management measurement technique for aiding BPM design. Logic could be applied to select which factors to measure. Logic could also be applied to determine which measurements are indicative for a particular factor. SDLC techniques and measurements have been developed and refined for a long time. The development and management of a system of process models is very similar to the development and management of a software system. The design of the present invention is to apply these same techniques and measurements to the BPM Design, to aid the improvement of the Modeling Development Life Cycle (MDLC). This approach is useful in a BPM design context because businesses change rapidly, as do their business processes, due to competition, regulations, mergers, and acquisitions, new products and services, etc. The BPM system content needs to keep pace with these changes, and is also an important tool that is used to facilitate business change. Therefore, the efficiency of the maintenance and operations of the BPM system is critical.

In a BPM context, a set of similar measures may also be utilized for aiding the BPM design process. Complexity, in a BPM design context, is the degree to which a system or component has a design or implementation that is difficult to understand or verify. Degree of complication is determined by such factors as interfaces, control structures, nesting, and data structures. The interface components in a BPM context are internal and external stakeholders, calendar and event-driven scheduling, inputs and outputs. Control structure facets include decision points, branching, iterations, parallel instances and junctions. Nesting aspects include: sub-processes, workflow services, platform and system services, tasks and functions. Functionality is the estimation of the value of a BPM system against the corresponding business system to guide BPM efforts. Maintainability, in a BPM design context, measures the effort and risk of making a change, correcting faults, improving performance, and adapting to a changed environment. Maintainability index is a formula that is based on complexity indicators such as Halstead and Cyclomatic complexity, and productivity indicators such as model design size. The scope of change in a group of BPM Designs may be weighed in terms of maintainability measure or index. A number of “coefficients” or parameters that are used in the formula, may be employed to indicate scope of change. Such changes may be required by influences such as new technologies, legal compliance, competition, restructuring, merger and acquisitions. Testability, in a BPM context, is the degree to which a design facilitates the establishment of testing criteria and allows for required tests and makes them efficient. This measurement may be a combination of cyclomatic complexity indicator and Function Point Analysis indicator. Structuredness, in a BPM context, is the degree to which a component possesses a pattern of organization of interdependence among parts. A BPM Design may be measured according to structuredness by determining the number or density of sub-components that are found within a modular library. A BPM Design may also be measured by how many operations are performed per sub-component. Understandability, in a BPM context, is the degree to which the purpose of the component is clear. Cyclomatic complexity is a useful indicator to apply to the measurement of understandability. Reliability, in a BPM context, is the ability of a system or component to perform its required functions under stated conditions for a specified period of time. Productivity, in a BPM context, is the size of effort required to produce a BPM Design. Metrics that indicate BPM size include: number of activities, number of actors, number of branches and junctions, number of deliverables, model size.

A number of indicators may be applied to the model data to support the calculation of the BPM measures described above. Such indicators include complexity, modularity, Function Point Analysis, Halstead Complexity, Maintainability Index, and Size (or density). Modularity may be indicated to quantify how “well-structured” a BPM Design is. A well-structured process model uses the same sub-components. It is grouped into logical blocks of activities and organized in a layered fashion. The number of activities per sub-component, and the number of sub-components per design are modularity indicators. Function Point Analysis may be applied as an indicator of a BPM Design. Process models contain logical entities such as decision points, resources, and deliverables that can be used to establish measures for comparisons, cost estimations, and productivity. This indicator applies to cost estimation, and to productivity.

Complexity may be measured for BPM models using cyclomatic complexity. This is a measure of the number of linearly independent paths through a model design. Cyclomatic complexity is a measure of the complexity related to the number of ways there are to traverse a process. This determines the minimum number of inputs needed to test all paths. The Cyclomatic complexity of a software module is calculated from a connected graph. The technique is based on Graph Theory. Edges, nodes and connected components are counted and used in the calculation. Other complexity measures that could be used include: essential complexity (size of structuredness); design complexity, time complexity (number of steps), space complexity (size of working storage), and computational complexity (number of operators). In a BPM context, process model designs by their very nature are a form of control flow with inputs, outputs, decision points, branching, and junctions. Therefore the Cyclomatic complexity may be computed for a BPM Design as well. Edges, nodes, and components can be determined at different levels of granularity: process, model, swim lane, activity, or for an actor. Halstead complexity may also be used in a BPM context. The Halstead formulas are based on counting of operands and operators. Process modeling equivalents may be derived from process path flows and branching constructs. One or more of these complexity indicators may be used as a measure or as an input to quantify complexity, maintainability, testability, or structuredness.

Maintainability Index may be used as an indicator for one or more measures of a BPM Design. Numerous BPM Designs may be monitored over time to calibrate coefficients and form a basis for estimating the rise of maintenance costs. Quantities of Maintainability index may be computed pertaining to location, business area, service line, location, and organization. Size or Density may be used as an indicator for one or more measures of a BPM Design. The most easily understood of the software indicators is size or density. It provides indicators such as lines of code. In a BPM context, size may be indicated by the number of elements in the BPM Design, the number of activities, or the number of man-hours that actors use to perform the process. The elements and components used to construct a BPM Design can be counted and inventoried by themselves, or ratios may be formed such as activities per swim lane.

At 540 the one or more measurements that were derived in 530 are utilized to aid BPM design. Generally, the measurements aid an organization's ability to analyze and improve or optimize business processes. The measurements may serve the planning and development of BPM Designs that describe the business processes. The measurements may serve techniques to facilitate management of BPM design. The value that the measurements provide may be the ability to improve the performance and quality of the BPM design effort. By measuring the designs produced, model developers are able to quantify quality of the work product, and so improve, estimate, and plan their work. Quality is improved when defects in the models are recognized and productivity is enhanced in the processes they develop. Basically there are two ways that these quality improvements can be made. First, the overall development, implementation, and maintenance of the BPM Designs may be enhanced. Second, the business processes that are modeled by the BPM Design may be enhanced through better understanding, modeling, analysis, and optimization. An exemplary utilization of the measurements is found in the presentation of a report to a business process analyst. The report may, for example, contain a series of measures showing the current status of the BPM Design. The report may, for example, be displayed on a monitor or sent to a printer. Embodiments of the invention use the calculated measurements by interpreting the effect of the measurements, and displaying a potential ill effect of the structure, or a potential benefit of using an alternative structure. For example, a portion of a design may be highlighted together with a warning that it is inherently risky. As another example, a portion of the design may be highlighted as presenting a possible advantage.

Still with regard to FIG. 5, some embodiments may make use of storage of one or more measurements from a first design at 550. In place of or in addition to the one or more measures themselves, model data may be archived from the first design. Other data may additionally be stored such as: the number of hours spent capturing the BPM Design, data relating to defects that are found, or the current size of the BPM Design. This data may be recorded to form a part of a project history log. This data may be archived into one or more of the datastores available to a system. This allows one or more methods of design evaluation to take place by a supervisor of the development process. The data may then be analyzed over time and over projects. The various steps in the BPM process may be refined with the objectives of improving the ability to estimate size and development time, reducing and removing defects. It is well known that catching defects earlier in the BPM design process decreases the cost of the defects. The cost of quality is then reduced by reducing the cost of BPM design reviews and evaluations. The measures may also be used for project estimation and planning, defect diagnosis and repair and increased productivity. The use of process metrics has the advantage that they may be applied across dissimilar BPM Designs, and a measure of development costs may be obtained that transcend business area.

Again with regard to FIG. 5, at 560 second model data is optionally obtained, so that a second set of measurements may be derived at 570. Embodiments obtain the model data from a design when it is created, edited, or saved, and a second set of measurements for the second design is stored in a datastore such as 214. When a second design is desired that is relatively similar to a current design, the datastore such as 214 is searched comparing the first and second set of measurements at 580. The closest matching BPM Design is then determined based on this comparison, and the best match is utilized for example at 540 by displaying the sets of measures side by side in a display. As those skilled in the art will appreciate, the closest match may be determined by the smallest absolute error in a particular measure from the set, or it may be determined by some function of all the measures such as a sum of the weighted absolute differences of each measure in the set, or a sum of the weighted squared errors between the measures in the two sets, or other distance metric. Thus the utilization at 540 of the measures obtained may be to find a closest existing BPM Design in a library compared to a given reference design. As those skilled in the art will appreciate, other variations are possible such as the embodiments which utilize the stored model data from existing designs rather than sets of stored measurements. In this case the second set of model data at 560 is obtained from a design stored in a datastore such as 214.

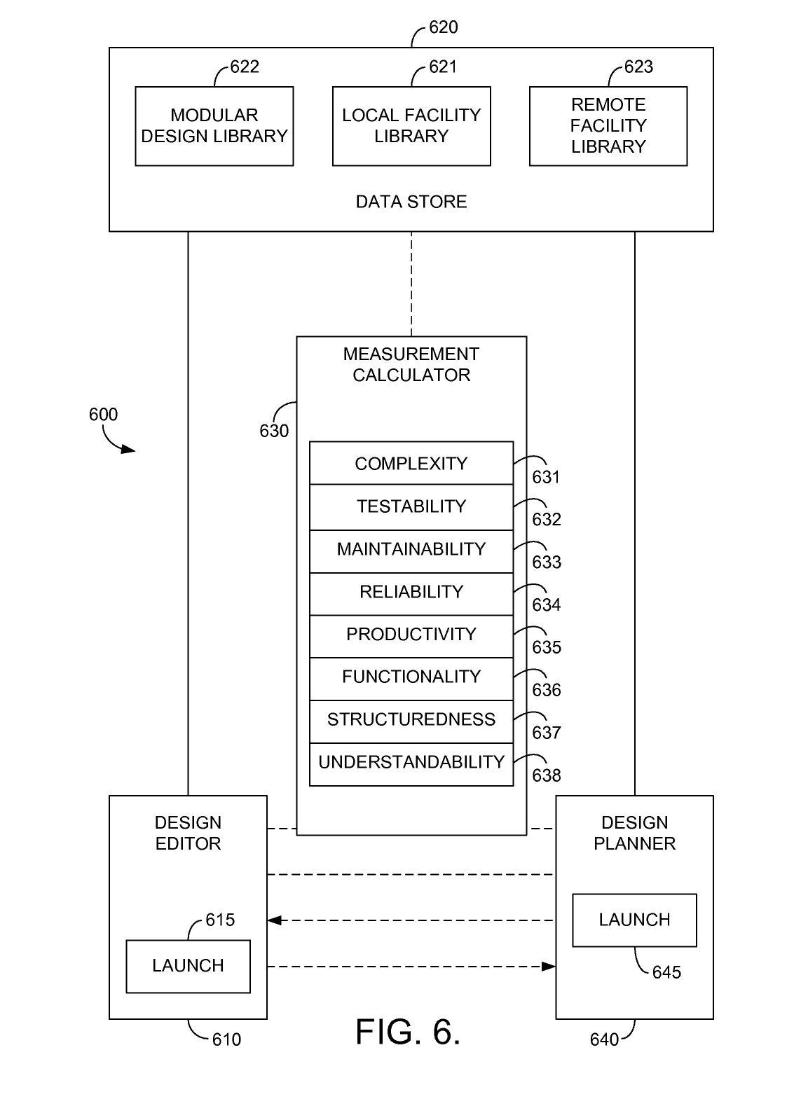

Turning now to FIG. 6, there is depicted in 600 an exemplary system for aiding the development of BPM Designs. A design editor 610 allows a first BPM Design to be created. The design editor 610 may also allow designs to be defined, edited, modified, saved, or retrieved. Such an editor may run as a component of a knowledge manager such as 210, or it may be a stand-alone application within a location such as 206. In some embodiments, the design editor 610 operates as a stand-alone application on one or more computers such as 28, or on a server such as 22. In some embodiments, the design editor 610 operates on both a remote computer 28 and a server 22 as a client/server application. In some embodiments the design editor 610 operates as a subcomponent to another application.

The design editor 610 is coupled to a datastore 620 for storing one or more BPM Designs which encompass constituent model data. The datastore 620 may be a database cluster such as 24, or a location database such as 214 or an optimized practice process model database such as 212, or it may simply be storage such as RAM or a disk within a computer such as 28. The datastore 620 includes at least one storage location for BPM Designs such as local library 621. Library 621 is called “local” in the sense that the design that is stored there describes a BPM model for at least one location such as 206. Library 621 may be physically located in a datastore such as 214, or it may be contained in a data warehouse such as 208, or it may simply comprise a portion of the RAM of a local computer such as 28. Embodiments of the datastore 620 include modular design library such as 622 for making available to the design editor 610 design templates or groups of prior designs that may be modified or adapted to create a present design. Embodiments of the datastore 620 include remote location library 623 which makes available to a design editor 610 BPM Designs that have been created to describe processes performed at a remote location such as 202. The datastore 620 is coupled to a measurement calculator 630 for computing a set of one or more measures of a BPM Design. These measures may for example include measures and indicators discussed above including one or more of complexity 631, testability 632, maintainability 633, reliability 634, productivity 635, functionality 636, structuredness 637, or understandability 638.

The system also includes a design planner 640 coupled to datastore 620. The design planner 640 functions to evaluate the BPM design process through the use of measures that have been calculated for one or more designs by measurement calculator 630. Embodiments of the design planner 640 obtain measurements from the datastore 620 as they have been stored by the measurement calculator 630, or the design editor 610. Other embodiments obtain the measures from the measurement calculator 630. The Design planner 640 uses the measurements to aid the development or management of the BPM design process, for example by presenting the measurements on a monitor for an operator to evaluate the measures of a given BPM Design. Other embodiments utilize the measurements by searching a library such as remote location library 623, modular design library 622 or local location library 621 for a design that has measurements closely approximating a reference BPM Design. Embodiments present the measurements side-by-side in a tabulated form for ease of comparison. Embodiments of the design planner 640 operate as a component of a knowledge manager 210. Embodiments of the design planner 640 allow a launch subcomponent 645 to initiate a design editor 610 that presents the selected design to the operator for review. Embodiments of the design editor 610 allow the design planner 640 to be initiated from a launch component 615. Thus embodiments of the design planner component 640 may be operated and accessible to the operator of a design editor 610. Likewise, embodiments of the design editor 610 may be accessible to the operator of a design planner 640.

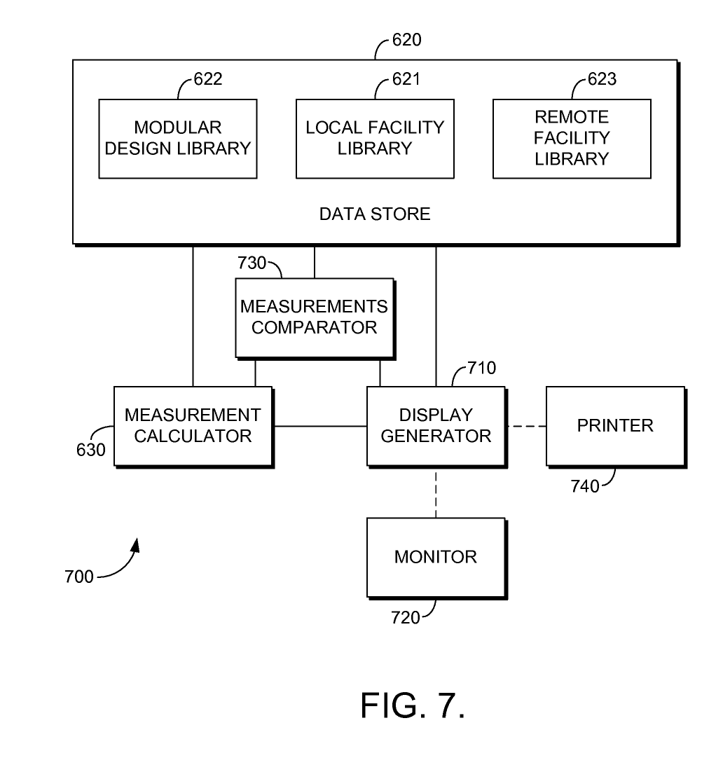

Turning now to FIG. 7, there is depicted in 700 an apparatus for analysis of BPM Designs. Again, a measurement calculator 630 is coupled to a datastore 620 comprising at least a local location library 621, and perhaps one or more other libraries such as a modular design library 622 or a remote location library 623. A display generator 710 is coupled to the measurement calculator 630, and operates to generate a display of information pertaining to a first set of one or more measurements that is made by the measurement calculator 630 with respect to model data from a first design. The information may be the raw measurement results themselves, displayed in numerical form, or it may be a graph, schedule, or distance generated based on the first set of one or more measurements. The information may merely be recorded, or optionally displayed on a monitor 720 or a printer 740.

Optionally, the display generator 710 may be coupled to a measurement comparator 730, which operates to derive a second set of one or more measurements based on a second design comprising second model data to form a second set of one or more measurements. The comparator 730 may operate as part of a search for the closest design in one or more libraries as compared to a first design. The display of the second design, or a file, folder, or index name related to this second design may be the result of this search. The display generator 710 may operate to express the distance, or a measurement based on the differences between a first and second set of one or more measurements as discussed previously. The display that is generated may be a display of the distances of one or more other designs as compared to a reference design. The display may take into account several close designs, or it may be based on a single nearest neighbor.

The display generator may extrapolate different aspects of the model development process on the basis of the measurements and/or the results of measurement comparator 730. For example, resource cost estimates for the first design may be made based on the similarity to a second design, and the resource utilization experienced in the second design. As a second example, maintenance cost estimates for a first design may be made based on the similarity to a second design, and the maintenance costs experienced in a second design. These cost estimates may then be used to generate a display by display generator 710 for presentation to the operator as an aid to performing resource planning. Alternatively, the similarity of the two designs may be used to help manage the schedule of a planned effort. A display may be generated indicating the risk of a schedule based on resource availability, and prior schedule experience. Such a display may include an extrapolated schedule, or a probability of early completion. As another alternative, the reliability of a first design may be estimated based on the similarity of a second set of designs, and the reliability experienced in the second set. A display may be generated on this reliability estimate such as an expression of a degree of risk, or a simple numerical display.

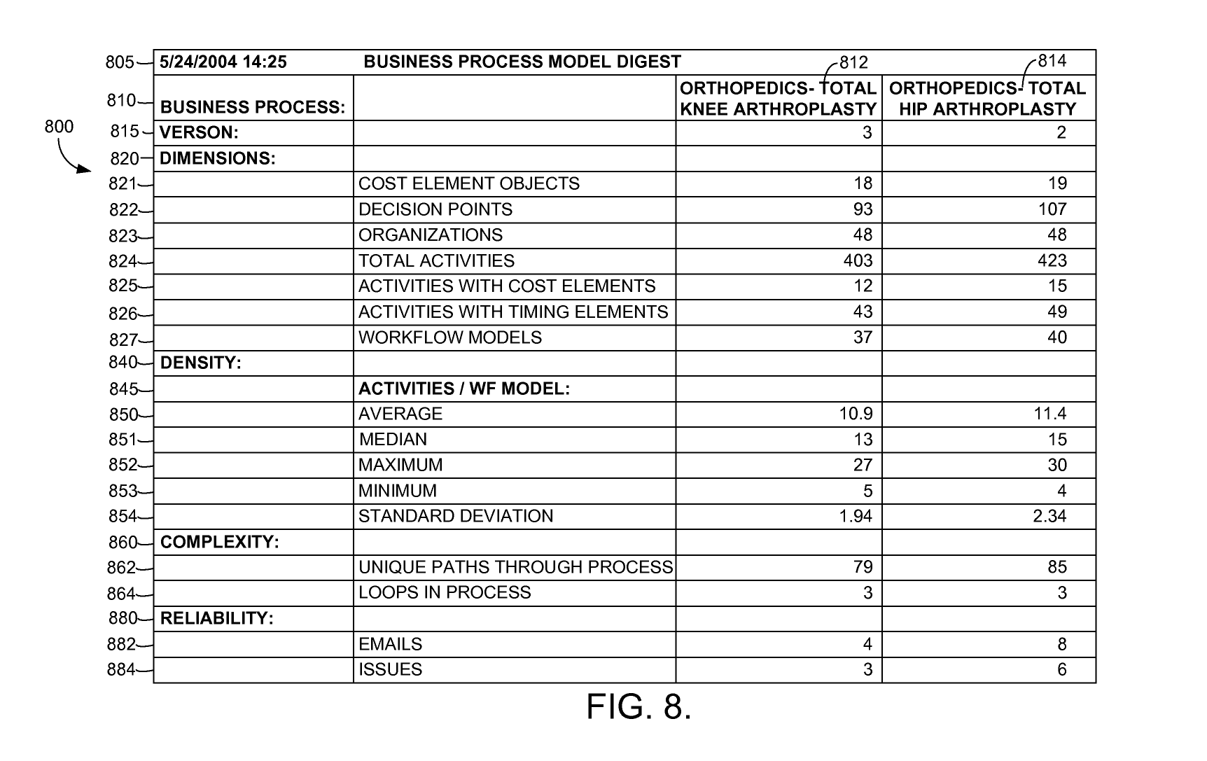

Turning now to FIG. 8, there is presented in 800 an exemplary display of two sets of BPM measurements. This display may, for example be displayed on a monitor 720 or a printer 740. The first row of this display 805 includes for example a date and time field and a title of the report displayed. The second row 810 identifies the business process that is modeled. This row identifies in 812 the identity of the first business process that is modeled, and in 814 the second business process modeled. The present example is taken from the healthcare field and compares models developed for two orthopedic surgical procedures: Total Knee Arthroplasty, and Total Hip Arthroplasty. Row 815 indicates the version of the process model designs that are being compared. Row 820 identifies the class of the first group of measures displayed, and indicates measures that have to do with dimension or size of the design. Row 821 identifies and compares the measures for “cost element objects”. Row 822 identifies and compares the measures for “Decision points”. Row 823 identifies and compares the measures for “organizations.” Row 824 identifies and compares the measures for “total activities”. Row 825 identifies and compares the measures of “activities with cost elements.” Row 826 identifies and compares the measures for “Activities with timing elements.” Row 827 identifies and compares the measures for “workflow models”. Those skilled in the art will appreciate that the dimensions category could also have incorporated deliverables, markets, people, roles, systems, major activities, measurements, process models, workflow links, workflow swim lanes, and maximum work delay.

Row 840 identifies the category of density measures. Row 845 identifies one particular density metric: “Activities/Workflow Model.” The next series of rows identify and compare aspects of this density metric including average 850, median 851, maximum 852, minimum 853, and standard deviation 854. Those skilled in the art will appreciate that other density metrics could also be expressed such as “Swim Lanes/Workflow Model”, “Objects/Workflow Model”, “Activities/Swim Lane”, “Levels/Major Activity”, or “Workflow Links/Workflow Model.” Row 860 identifies the next group of measures as relating to complexity. Row 862 identifies and compares the number of unique paths through each process. Row 863 identifies and compares the number of loops in each process. Those skilled in the art will appreciate that other complexity measures could also be presented such Fan-in/Workflow Swim Lane, or Fan-out/Workflow Swim Lane. Row 880 identifies the next group of measures as those having to do with reliability. Row 882 identifies and compares the measures of the two processes with respect to number of related emails. Row 884 identifies and compares the two processes with respect to issues that have been raised. Those skilled in the art will appreciate that other reliability measures could have been used for display such as files, rules, notes, and URL's.

As can be understood, the present invention provides systems, methods and apparatuses for aiding the development of BPM design. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. A computer-implemented method for aiding the development of a Business Process Model (BPM) design comprising: creating at least one BPM design, said at least one BPM design comprising first model data; storing said at least one BPM design in a datastore; deriving a first set of one or more measurements based on said first model data; and utilizing said one or more measurements as an aid to BPM design.

2. The method of claim 1, further comprising storing said first set of one or more measurements in said datastore.

3. The method of claim 2, wherein said step of storing said first set of one or more measurements comprises storing time of measurement to form part of a project history log.

4. The method of claim 1, further comprising storing said first model data to form part of a project history log.

5. The method of claim 4, wherein said step of storing said first model data comprises storing time of storage.

6. The method of claim 1, further comprising obtaining second model data from a second design.

7. The method of claim 6, further comprising deriving a second set of one or more measurements based on said second model data from said second design.

8. The method of claim 7, further comprising comparing said first set of measurements to said second set of measurements.

9. The method of claim 1 wherein said utilizing step comprises display of said first set of one or more measurements to a user.

10. A computer-implemented system for aiding development of a Business Process Model (BPM) design comprising: a design editor for creation of at least one BPM design, said at least one BPM design comprising model data; a datastore coupled to said design editor for storing said at least one BPM design; a measurement calculator coupled to said datastore for deriving one or more measurements based on said model data; and a design planner coupled to said datastore, configured to utilize said one or more measurements as an aid to BPM design.

11. The system of claim 10, wherein said design editor comprises a subcomponent that launches said design planner.

12. The system of claim 10, wherein said design planner comprises a subcomponent that launches said design editor.

13. The system of claim 10, wherein said datastore comprises a design library of modular designs.

14. The system of claim 10, wherein said datastore comprises a design library created by a remote location.

15. The system of claim 10, wherein said measurement calculator computes a measurement quantifying complexity.

16. The system of claim 10, wherein said measurement calculator computes a measurement quantifying maintainability.

17. The system of claim 10, wherein said measurement calculator computes a measurement quantifying Testability.

18. The system of claim 10, wherein said measurement calculator computes a measurement quantifying reliability.

19. The system of claim 10, wherein said measurement calculator computes a measurement quantifying productivity.

20. An apparatus for analysis of Business Process Model (BPM) design comprising: a datastore comprising at least one BPM design, said at least one BPM design comprising model data; a measurement calculator coupled to said datastore, operative to derive a first set of one or more measurements based on said first model data from said first BPM design; and a display generator coupled to said measurement calculator, operative to display information pertaining to said first set of one or more measurements to a user.

21. The apparatus of claim 20, wherein said measurement calculator is operative to derive a second set of one or more measurements based on second model data from a second BPM design.

22. The apparatus of claim 21, further comprising a measurement comparator.

23. The apparatus of claim 20, wherein said display generator is operative to generate a display of said first set of one or more measurements.

24. The apparatus of claim 22, wherein said display generator is operative to generate a display quantifying similarity of said second BPM design to said first BPM design.

25. The apparatus of claim 22, wherein said display generator is operative to generate a display quantifying estimates of resource costs of said first BPM design based on resource utilization of said second BPM design.

26. The apparatus of claim 22, wherein said display generator is operative to generate a display quantifying estimates of maintenance costs of said first BPM design based on maintenance utilization of said second BPM design.

27. The apparatus of claim 22, wherein said display generator is operative to generate a display quantifying estimates of project plan risk of said first BPM design based on plan utilization of said second BPM design.

28. The apparatus of claim 22, wherein said display generator is operative to generate a display quantifying estimates of project schedule of said first BPM design based on actual schedule of said second BPM design.

29. The apparatus of claim 22, wherein said display generator is operative to generate a reliability estimate of said first BPM design based on reliability experienced in said second BPM design.

30. The apparatus of claim 22, wherein said datastore comprises data from at least two locations.
